(19) United States
(12) Patent Application Publication
(10) Pub. No.: US 2007/0155222 A1
(43) Pub. Date: Jul. 5, 2007

(54) INDICATION CIRCUIT FOR INDICATING OVERHEATING OF MOTHERBOARD

(75) Inventor: Xiang Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/306,521

(22) Filed: Dec. 30, 2005

(51) Int. Cl. H01R 3/00

(52) U.S. Cl. 439/490

(57) ABSTRACT

An indication circuit for indicating overheating of motherboard includes: a chip disposed on the motherboard, a temperature controlling circuit sensing the temperature of the chip, and generating a pulse signal, a switch circuit connected to an output terminal of the temperature controlling circuit for receiving the pulse signal, and an LED. A first high-level voltage is provided to an anode of the LED, a second high-level voltage is provided to the switching circuit, and the switching circuit is simultaneously connected to a cathode of the LED. When the temperature of the chip is higher than a predetermined threshold temperature, the temperature controlling circuit will send the pulse signal to the switching circuit, and the LED is controlled to flash by the switching circuit to indicate overheating.

### FIELD OF THE INVENTION

The present invention relates to indication circuits, and more particularly to an indication circuit for indicating computer problems caused by overheating of a motherboard.

### DESCRIPTION OF RELATED ART

During operation, it is not uncommon for a user to experience computer problems. The symptoms of the problems may vary, such as, the computer no longer accepting input or failing to produce output, no image or frozen image on the monitor, computer system failing to initialize, programs becoming inoperable and so on. The root causes of these symptoms may vary as well, such as, overheating, improper matching of equipment, system files damaged, operator error and so on. Therefore, the cause of the problems is not readily apparent to the users.

With the development of the computer industry, the operating speeds of computers have become much faster. Accordingly, the heat generated by the internal electronic components of the computer is much greater than before. If the heat cannot be dissipated in a timely manner, the computer may exhibit some or all of the symptoms as described above. If there isn't any indication to show that the problem is caused by overheating of a motherboard, users may waste a lot of time as they work to exclude the possibilities one by one.

Accordingly, what is needed is an indication circuit for indicating when computer problems may be caused by overheating of a motherboard.

### SUMMARY OF INVENTION

An indication circuit for indicating overheating of motherboard includes: a chip disposed on the motherboard, a temperature controlling circuit sensing the temperature of the chip, and generating a pulse signal, a switch circuit connected to an output terminal of the temperature controlling circuit for receiving the pulse signal, and an LED. A first high-level voltage is provided to an anode of the LED, a second high-level voltage is provided to the switching circuit, and the switching circuit is simultaneously connected to a cathode of the LED. When the temperature of the chip is higher than a predetermined threshold temperature, the temperature controlling circuit sends the pulse signal to the switching circuit, and the LED is controlled to flash by the switching circuit to indicate overheating.

Other advantages and novel features will be drawn from the following detailed description of preferred embodiments with attached drawings, in which:

### BRIEF DESCRIPTION OF DRAWINGS

FIG. 1 is a schematic block diagram of an indication circuit for indicating overheating of a motherboard in accordance with a preferred embodiment of the present invention, the indication circuit including a switching circuit, a connector, and an LED;

FIG. 2 is a circuit diagram of the switching circuit of FIG. 1;

FIG. 3 is a circuit diagram of the connection between the connector and the LED of FIG. 1; and

FIG. 4 is a circuit diagram of the switching circuit in accordance with an alternative embodiment of the present invention.

### DETAILED DESCRIPTION

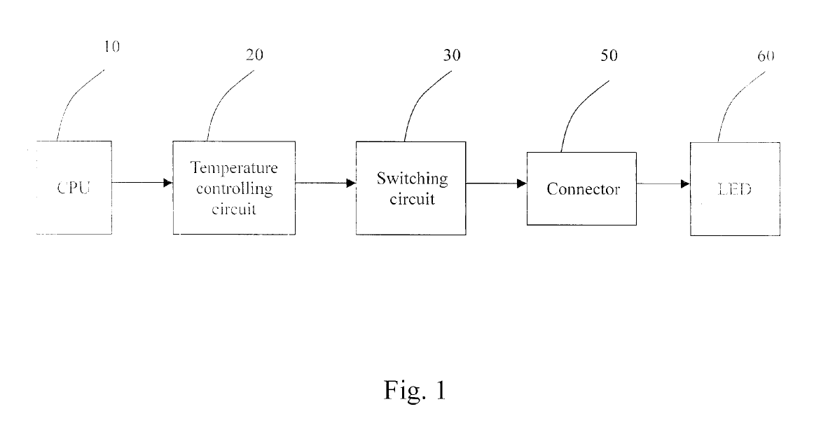

Referring to FIG. 1, an indication circuit for indicating overheating of a motherboard in accordance with a preferred embodiment of the present invention includes a CPU (central processing unit) 10, a temperature controlling circuit 20, a switching circuit 30, respectively disposed on the motherboard and an LED (light emitting diode) 60.

The temperature controlling circuit 20 is connected to the CPU 10. When the temperature of the CPU 10 is higher than a predetermined threshold temperature, a pulse signal is produced by the temperature controlling circuit 20, and sent to an input terminal of the switching circuit 30.

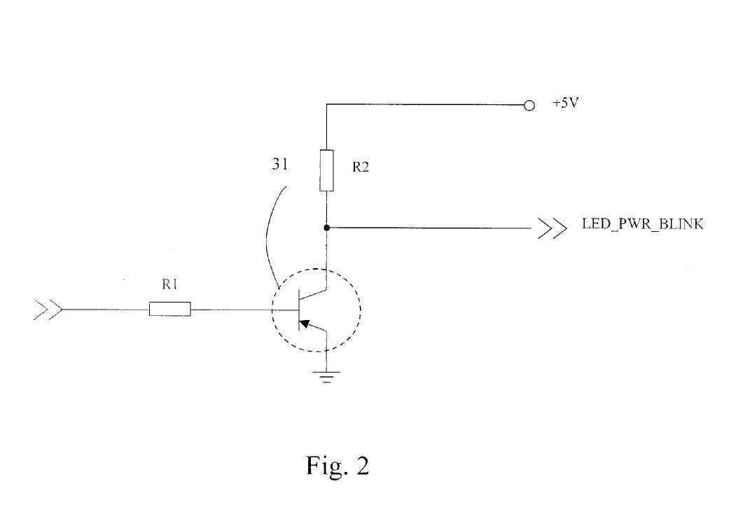

Referring also to FIG. 2, the switching circuit 30 includes a switch component. The preferred embodiment of the switch component is a PNP type transistor 31. A first resistor R1 is connected between the input terminal of the switching circuit 30 and a base electrode of the transistor 31. An emitter electrode of the transistor 31 is connected to ground. A +5V high-level voltage is provided to a collector electrode of the transistor 31 via a second resistor R2, and the collector electrode of the transistor is simultaneously connected to a cathode of the LED 60.

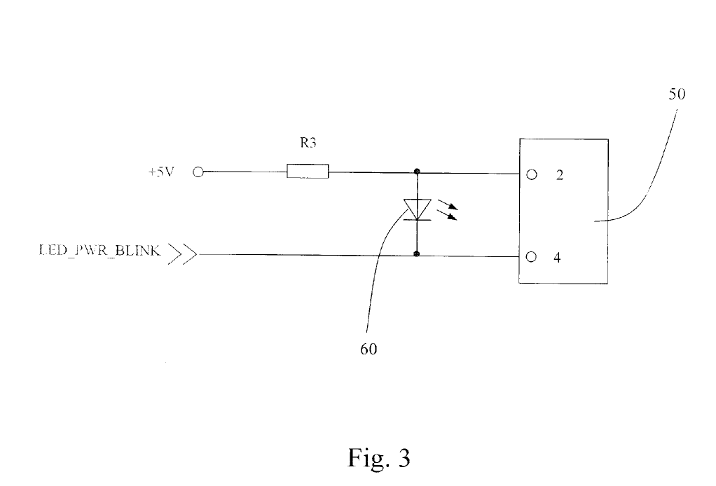

Referring also to FIG. 3, the indication circuit further includes a connector 50. The connector 50 has a pin 2 and a pin 4. Another +5V high-level voltage is provided to the pin 2 via a third resistor R3, and the pin 2 is simultaneously connected to an anode of the LED 60. The pin 4 is connected to a cathode of the LED 60, and the cathode of the LED 60 is also connected to an output terminal of the switching circuit 30, that is, connected to the collector electrode of the transistor 31. In the preferred embodiment, the connector 50 is set for connecting the LED 60 to the motherboard conveniently. In another embodiment, the connector 50 can be omitted, and the +5V high-level voltage directly provided to the anode of the LED 60. The cathode of the LED 60 is directly connected to the output terminal of the switching circuit 30.

When the temperature of the CPU 10 is higher than the predetermined threshold temperature value, the temperature controlling circuit 20 sends a pulse signal to the input terminal of the switching circuit 30. The signal alternates between a high-level and a low-level. When the signal is high-level, the transistor 31 does not conduct and the +5V high-level voltage is output to the anode and the cathode of the LED 60 simultaneously. Since there is no voltage difference between the anode and the cathode of the LED 60, the LED 60 does not emit light. Contrarily, when the pulse signal is low-level, the transistor 31 conducts, and the low-level voltage is sent to the pin 4 of the connector 50, and thus to the cathode of the LED 60. Now, there is a voltage difference between the anode and cathode of the LED 60, and the LED 60 emits light. In this manner, when the CPU 10 is overheating, the LED 60 will flash, alerting users to the problem.

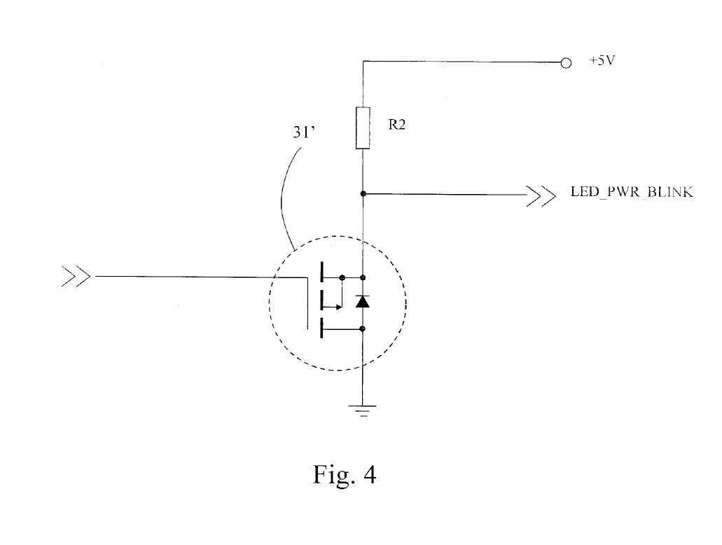

FIG. 4 shows an alternative embodiment of the switching circuit 30. In this embodiment, the switch component of the switching circuit 30 is a P-channel-strengthen MOSFET (metal-oxide-semiconductor field-effect transistor) 31′. A gate electrode of the MOSFET 31′ is connected to the output terminal of the temperature controlling circuit 20. A drain electrode of the MOSFET 31′ is connected to ground. A +5V high-level voltage is provided to a source electrode of the MOSFET 31′ via a second resistor R2, and the source electrode of the MOSFET 31′ is connected to the pin 4 of the connector 50 simultaneous.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An indication circuit for indicating overheating of a motherboard, comprising:
a chip disposed on the motherboard;
a temperature controlling circuit sensing the temperature of the chip, and generating a pulse signal when the temperature of the chip is higher than a predetermined threshold temperature; a switching circuit connected to an output terminal of the temperature controlling circuit for receiving the pulse signal; and
an LED, wherein a first high-level voltage is provided to an anode of the LED, and the switching circuit is connected to a cathode of the LED for controlling the LED to emit a flashing light.

2. The indication circuit as described in claim 1, further comprising a connector having a first pin and a second pin, the first high-level voltage provided to the first pin, and the second pin connected to the output terminal of the switching circuit.

3. The indication circuit as described in claim 2, wherein the anode of the LED is connected to the first pin of the connector, and the cathode of the LED is connected to the second pin of the connector.

4. The indication circuit as described in claim 1, wherein the switching circuit comprises a PNP type transistor, a base electrode of the PNP type transistor is connected to the output terminal of the temperature controlling circuit, an emitter electrode of the PNP type transistor is connected to ground, and a collector electrode of the PNP type transistor is connected to the cathode of the LED.

5. The indication circuit as described in claim 4, wherein the switching circuit comprises a first resistor connected between the output terminal of the temperature controlling circuit and the base electrode of the PNP type transistor.

6. The indication circuit as described in claim 4, wherein the first high-level voltage is provided to the anode of the LED via a second resistor, and a second high-level voltage is provided to the collector electrode of the PNP type transistor via a third resistor.

7. The indication circuit as described in claim 1, wherein the switching circuit comprises a P-channel-strengthen MOSFET, a gate electrode of the P-channel-strengthen MOSFET is connected to the output terminal of the temperature controlling circuit, a drain electrode of the P-channel-strengthen MOSFET is connected to ground, and a source electrode of the P-channel-strengthen MOSFET is connected to the cathode of the LED.

8. The indication circuit as described in claim 7, wherein the first high-level voltage is provided to the anode of the LED via a second resistor, and a second high-level voltage is provided to the source electrode of the P-channel-strengthen MOSFET via a third resistor.

9. An indication circuit for indicating overheating of a motherboard, comprising:
a temperature controlling circuit for sensing the temperature of the motherboard, and
generating a pulse signal when the temperature of the chip is higher than a predetermined threshold temperature a switching circuit connected to the temperature controlling circuit for receiving the pulse signal; and
an LED connected to the switching circuit;
wherein the switching circuit controls the LED to emit a flashing light according to the pulse signal received from the temperature controlling circuit.

10. The indication circuit as described in claim 9, wherein the switching circuit comprises a PNP type transistor, a base electrode of the PNP type transistor is connected to an output terminal of the temperature controlling circuit via a first resistor, an emitter electrode of the PNP type transistor is connected to ground, a collector electrode of the PNP type transistor is connected to a cathode of the LED.

11. The indication circuit as described in claim 10, wherein a first high-level voltage is provided to an anode of the LED via a second resistor, and a second high-level voltage is provided to the collector electrode of the PNP type transistor via a third resistor.

12. The indication circuit as described in claim 9, wherein the switching circuit comprises a P-channel-strengthen MOSFET, the gate electrode of the P-channel-strengthen MOSFET is connected to an output terminal of the temperature controlling circuit, a drain electrode of the P-channel-strengthen MOSFET is connected to ground, and a source electrode of the P-channel-strengthen MOSFET is connected to a cathode of the LED.

13. The indication circuit as described in claim 12, wherein a first high-level voltage is provided to the anode of the LED via a second resistor, and a second high-level voltage is provided to the source electrode of the P-channel-strengthen MOSFET via a third resistor.
